(19) United States
(12) Patent Application Publication
(10) Pub. No.: US 2020/0220927 A1
(43) Pub. Date: Jul. 9, 2020

(54) ACTIVITY SYNCHRONIZATION

(71) Applicant: Dahyu Patel, Ashburn, VA (US)

(72) Inventor: Dahyu Patel, Ashburn, VA (US)

(21) Appl. No.: 16/243,961

(22) Filed: Jan. 9, 2019

(51) Int. Cl. H04L 29/08; G06N 10/00; G08B 7/06

(52) U.S. Cl. CPC H04L 67/1095; H04N 5/23203; G08B 7/06; G06N 10/00

(57) ABSTRACT

The present invention includes an activity synchronization system and process that relies on sensations applied to an entity during an activity to inform the entity as to its progress through the duration of an activity.

### FIELD OF THE INVENTION

The present invention relates to the field of sociology and more specifically to the field of synchronization of processes with time restraints.

### BACKGROUND

There are all types of timers and industry leaders have been fascinated by the speed of the human in thought and action, and how an individual human, under appropriate circumstances, can often operate at levels greater than he believes himself capable. Humans think that they can master the seconds in their lives. Timers used to date (physical—watches, stand-alone timers, hour glasses; software—mobile app and desktop websites) have just alerted you at the very end through a sound/beep that your timer session has ended. People today use various timers to get work done but they all generally have one commonality—they let you know when zero seconds has reached. If people knew about their time remaining in an activity, throughout the course of the activity, their behavior would shift and be hyper focused at the task hand. Timers today are designed to work in independent/solo mode with little accountability; but if a timer solution had a synchronization and/or alerting ability to with work in parallel with others to achieve something against the same time allotment, then a faster progress would be more likely.

So timers today are boring “after-the-factish” and unhuman—they do not access humanity's flight/fight response system, particularly in tapping into the good stress that could work to all our advantages. Special Ops in the military are fundamentally knowledgeable about speed and hitting their target outcomes on time, possibly because their training contains commonalities. A primary commonality was: “simply work under time pressure; you will think faster, problem solve faster, become immune to stressful situations and welcome good stress more.” Therefore, timers today lack, user cue configurations (setting tones, voice, haptic feedback) to let you and others around you where you are in time and also a syncing aspect of timers. For example, the iWatch has a timer, but what if one wanted to sync timers with other people who are moving against the same deadline to get things done and they all heard the same tonal cues wherever they may be around the world; they would get things done together in time and any one person in the group would energize everyone else around them in the process.

There is a solution being used by Google Ventures and throughout the Google company for brainstorming meetings that delivers results in five day sprints; they use a timer called Time Timer. This timer is more about visualization: there's a clock that gives users 60 mins, and it's a circle and when time diminishes so does the RED circle so as to signify how much time left through visual cue. A circle is an inefficient way of getting people in a room to move towards completing something on time and creating true social connection and collaboration. A set of cues set up throughout the timed event will deliver better results than this type of timer.

Therefore, there is a need for timing solution that is more robust than simply identifying a zero-moment at the conclusion of an activity. There is a need for a timer that connects with humanity's inherent sense systems, in a way to tap into its fight-or-flight instincts. A timer should be capable of creating/harnessing “good pressure” to accomplish significant results.

### SUMMARY

The present invention is directed to an activity synchronization process. The activity synchronization proves includes connecting a first computer operated by a first entity to a second computer operated by a second entity over a communication network supporting an audiovisual/haptic communication protocol for an interaction activity. The interaction activity may include any activity that requires the collaboration of multiple entities to achieve a result. A quantification layer is added to the interaction activity, which conceptually divides the activity into multiple discrete quanta with at least two quantum boundaries. The activity is initiated, and during the activity, the first entity is alerted to the quantum boundaries with an integral, substantially silent sensation having a magnitude logically correlated to a relationship between said quantum boundary relative to said interaction activity.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a view of the process of the present invention.

FIG. 2 is a view of the process of the present invention.

FIG. 3 is a view of the process of the present invention.

FIG. 4 is a view of the process of the present invention.

FIG. 5 is a view of the ecosystem of the present invention.

FIG. 6 is a view of the ecosystem of the present invention.

FIG. 7 is a view of the ecosystem of the present invention.

FIG. 8 is a view of the process of the present invention.

FIG. 9 is a view of the process of the present invention.

FIG. 10 is a view of the process of the present invention.

FIG. 11 is a view of the process of the present invention.

FIG. 12 is a view of the process of the present invention.

### DETAILED DESCRIPTION

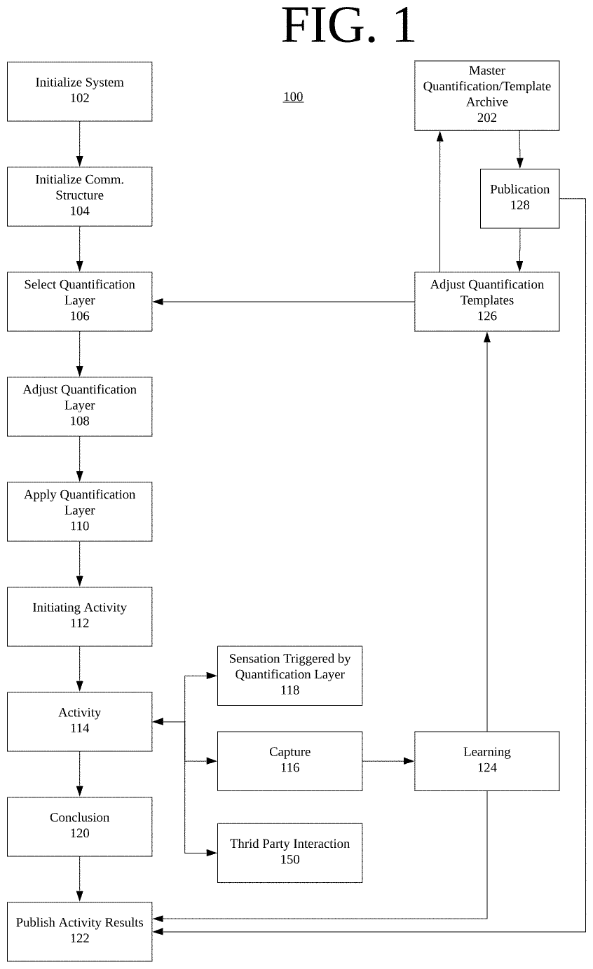

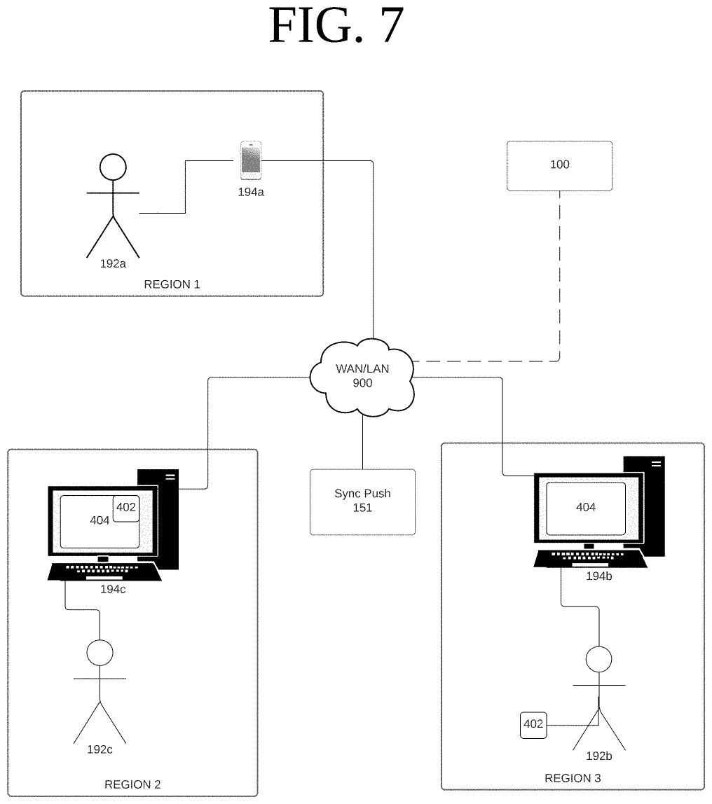

Referring first to FIGS. 1-2, 7-8, a basic embodiment of the activity synchronization process 100 is shown. The activity synchronization process 100 includes initializing 102 the activity synchronization system. The initializing step 102 includes all steps effective to open the system 100 for future use of the system 100 on at least one entity machine. The machine of the present invention may differ from entity-to-entity, but advantageously includes storage 206 and an arithmetic logic unit 204 (“ALU”).

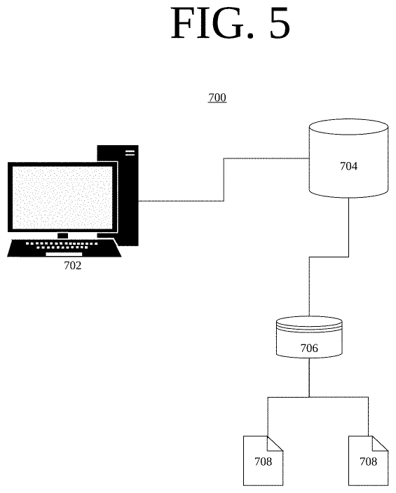

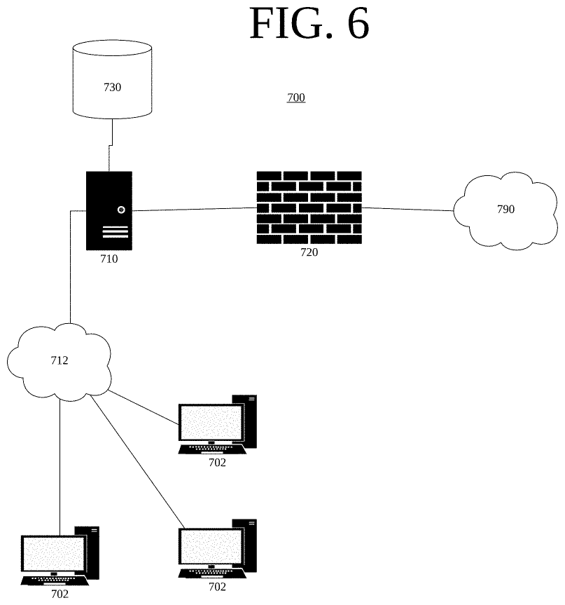

FIGS. 5-6 depict a computer ecosystem 700 of the present invention. By ecosystem it is meant one or more computers 702 that are organizationally related. The ecosystem may include computers under common ownership, computers that belong to the same network or series of networks, computers that are collaborating, etc. The present invention may be provided as a computer program product, or software that may include a computer-readable storage medium 704 having stored thereon instructions, which may be used to perform the process of the present invention across a computer ecosystem 700 according to the various embodiments disclosed herein.

A computer 702 of the present invention may include any combination of one or more computer readable media 704. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium 704 may be any tangible medium that can contain, or store a program for use by or in connection with an instruction execution system, apparatus, or device.

A computer readable signal medium 704 may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures described below illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Furthermore, the functionality of one block may be subsumed by the functionality of another block as a substep thereof. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

An ecosystem 700 may further include a computer network or data network that allows computers to exchange data. In a computer network of the present invention, networked computing devices pass data to each other along data connections. The connections between nodes are established using cable media, wireless media, or other media. The Internet or other exterior network 790 may be a component of the ecosystem 700. Nodes may include hosts such as personal computers, phones, servers, and networking hardware. Two such devices are networked together when one device is able to exchange information with the other device, whether or not they have a direct connection to each other. Computer networks of the present invention support applications such as access to the World Wide Web, shared use of application and storage servers, printers, and fax machines, and use of email and instant messaging applications. Computer networks may be included irrespective of the physical media used to transmit their signals, the communications protocols to organize network traffic, the network's size, topology, and organizational intent.

It is preferred that the network of the present invention have at least one boundary 720, and potentially multiple boundaries if a demilitarized zone is utilized. The boundary 720 may include any number of layers designed to regulate and secure the flow of information between networks. Boundary layers of the present invention may include enterprise content management software, firewalls, filters, threat management software, alarms, etc. Software for establishing a boundary may be run on a server 710 with server storage 730 of the present invention, which may include directory services controlling access credentials.

To combat security risks posed by network connections, firewalls are frequently used. A firewall may be a hardware or software component that filters network traffic so that communications with unauthorized third parties are blocked but legitimate network functions may be carried out. Frequently, the filters applied by a firewall are specified by a set of policies defining characteristics of network messages that either should pass through the firewall or that should be blocked. Because different levels of communication may be appropriate depending on the origin or destination of messages, firewall policies may be provided for each application that executes on a computing device and communicates over a network.

A firewall may have an outward side facing a global network, such as the Internet. The opposite side of the firewall may be a private network that is protected by the firewall. The private network may include any number of host machines (e.g., computers) each addressable by its own IP address. The physical construction of the network may be such that all data packets intended for one of the IP addresses behind the firewall pass through the firewall. Using the firewall rules, which may be set by a network administrator or other user, the firewall may determine whether to allow or deny certain data packets and/or determine where to route particular data packets based on the IP addresses to which the packets are directed. The determination of where to route data packets may be done using the IP addresses of the host machines in the private network.

Depending on the addressing scheme used by the network, the IP addresses of the host machines may be static or dynamic. Static IP addresses do not change over time, and thus once they are set in the firewall rules, there is no need to update them. The Internet Protocol version Four (IPv4) addressing system commonly uses static addressing, while IPv6 may use dynamic addressing. Dynamic IP addresses may change over time and thus, there is a need to update the firewall rules as changes occur. When a small Local Area Network (LAN), such as a domestic network in a private residence, is linked to a larger network such as the Internet, the link is often through a gateway router acting as a firewall. One of the functions of the firewall is to protect the LAN from intrusion from outside.

A service directory accessible by a server 710, usually on server storage 730, stores information about network resources across a domain. An example of a directory service is Active Directory. The main purpose of Active Directory is to provide central authentication and authorization services for Windows-based computers. Active Directory also allows administrators to assign policies, deploy software, and apply critical updates to an organization. Active Directory stores information and settings in a central database.

An Active Directory structure is a hierarchical framework of objects. The objects fall into three broad categories: resources (e.g. printers), services (e.g. e-mail) and users (e.g., user accounts and groups). The Active Directory provides information on the objects, organizes the objects, controls access and sets security. Certain objects can also be containers of other objects. An object is uniquely identified by its name and has a set of attributes—the characteristics and information that the object can contain—defined by a schema, which also determines the kind of objects that can be stored in the Active Directory.

Typically, the highest object in the hierarchy is the domain. The domain can be further sub-divided into containers called Organizational Units. Organizational units give a semblance of structure to the organization either based on administrative structure or geographical structure. The organizational unit is the common level at which to apply group policies, which are Active Directory objects themselves called Group Policy Objects. Policies can also be applied to individual objects or attributes as well as at the site level (i.e., one or more IP subnets).

The present invention may use one of more communication networks to foster information exchange throughout the computers of the ecosystem. Communication networks might either be private or public. In a private network, communications between multiple computers occur in a secure environment that prevents access from outside the network without appropriate authentication. These networks are considered as “trusted” networks because the communication signals securely travel from one computer to another within the private network without being exposed to the external environment.

Public networks such as the Internet, on the other hand, are not secure because the communication over these networks is not private and is susceptible to interception by other computers. In addition, the public networks cannot guarantee the delivery of the data packets being sent. They allow packets to be injected into, or ejected out of, the networks indiscriminately, and analyzed while in transit. To keep data sent over a public network private, a Virtual Private Network (VPN) is commonly established on top of a public network when two computers use the public network to communicate with each other. In a Virtual Private Network, data sent from one computer to another is encrypted by a security gateway and transmitted in encrypted form over the public network to a second security gateway connected to the receiving computer. The second gateway decrypts the data before forwarding it to the receiving computer. Such a private channel established on top of another network is referred to as a network tunnel.

In order to set up a Virtual Private Network, a user first establishes a path to a VPN server and goes through an AAA process (Authentication, Authorization and Accounting) for identification and authorization to create a secure tunnel with the server. Once the user is authorized, a secure network tunnel is established between the user and the VPN server over the public network, using a VPN protocol such as IPsec. This process requires a VPN client on the user's side, a VPN server and other VPN hardware on the other side of the tunnel, as well as appropriate user configurations.

Today's private networks often include wireless networks such as WiMAX to accommodate mobile access. In addition, to provide mobility access in a large geographic area, a private enterprise often relies on third-party wireless infrastructures besides its own wireless network. In this case, a user's device would need to be authenticated by both a third-party gateway and an enterprise authentication server before it could access the enterprise network. User credentials are typically requested by and securely returned to the third-party gateway. Once the user is authenticated and authorized, the user may communicate with the third-party wireless gateway.

The present invention includes files 708, which may include executable instructions by which the present invention runs, or files upon and with which the present invention interacts. The documents may be on local storage 704 or shared storage 730 and be created, accessed, edited, and/or otherwise modified using any of a number of applications, including for example and without limitation Final Cut Pro, Avid, Microsoft Office applications (Word, Excel, Power Point, Outlook, Visio, etc.), Adobe Reader or Acrobat, AutoCAD, SolidWorks, or any other suitable document editing application. The content of the documents may be audio tracks, video clips, images, word processing documents, presentations, spreadsheets, business documents, engineering documents, databases, etc.

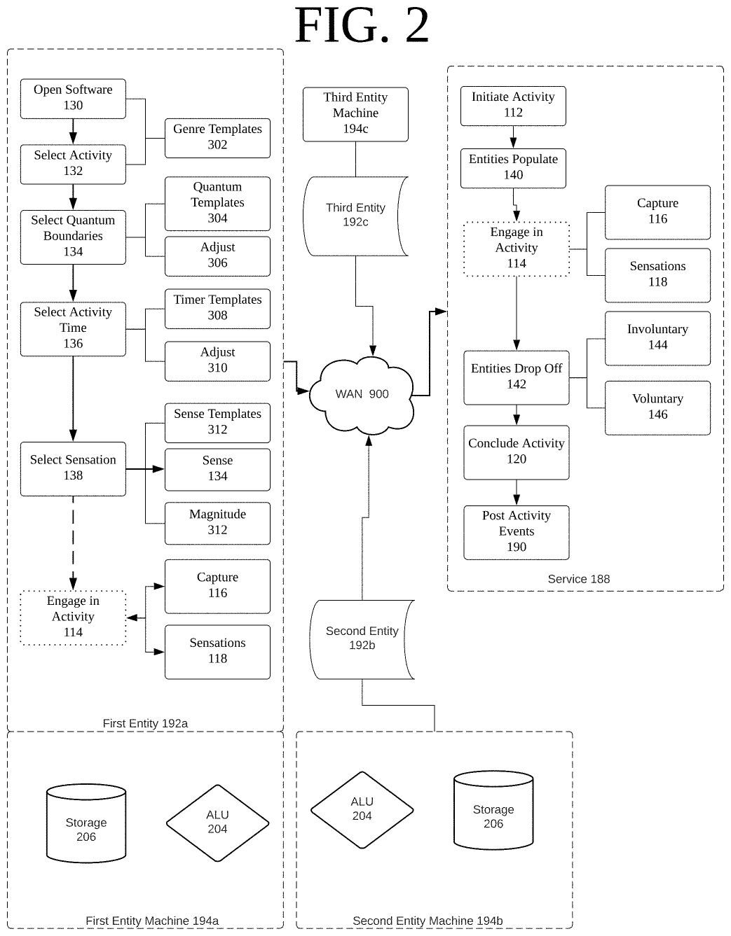

Returning to FIGS. 1-2, the present invention initializes 104 a communication structure applicable to operate the system 100. This may be the activation of such devices on a computer effective to operate over a WAN or a LAN or direct computer-to-computer connections. Functions applicable to the Internet Layer of the TCP/IP reference model are activated in this step 104.

A user that opens 130 software, or other file containing instructions to perform the present invention, may be presented with a list of preselected interactive activities. The present invention is intended to assist a user conduct interactive activities, particularly engage in meetings, phone calls, public speaking, presentations, teaching, consulting, advising, and other interactive activities wherein time and goals are a pertinent factor. For example, in a meeting, a presenter may have a range of topics to discuss and pre-establish a set time for the meeting along with a participant list. An effectively run meeting fully delves into the applicable topics and does so pursuant to a predetermined time. Thus, an interactive activity may be subdivided into partitions, or quanta, having quantum boundaries wherein each quanta is correlated to a topic, and each boundary is the point of transition from one topic to the next topic. This may be similarly applicable to teaching a lesson or other educational activity wherein each quanta is correlated to an educational issue, and each boundary is the point of transition from one issue to the next issue. In a meeting regarding filing a patent application, an attorney may be present as the first entity 192a and be speaking with inventors as a second entity 192b and a third entity 192c. The topics may include (i) the disclosure necessary to create a patent application and perform a search for prior art, (ii) the legal ramifications of filing a patent application, (iii) the timing and actions by the USPTO, (iv) enforcing and licensing a patent application, (v) attorneys' fees related to patent activities, and (vi) questions from the inventors. Because legal advice is an expensive service it is important to conduct legal advising conferences in a timely manner. In the mentioned example, there are six quanta and therefore at least five quantum boundaries (one between each quanta). Although the number of quantum boundaries will generally be the number of quanta minus one, this need not be the case as the beginning and end of a boundary may be considered a quantum (which would make the quanta number, n+1). Rather, the significance of the quantum boundaries for purposes of the present invention is that a participant in an interactive activity has a logically divided interactive activity.

The quanta may be determined by the genre of the interactive activity intended by the first entity 192a. By genre, it is meant the overall category of the activity, which for the example above may include “legal” or as granular as “patent application filing discussion.” The genre of activities may be first captured and then supplied as genre templates 302 available to the system and the first user. The genre templates may be made available because the first user has engaged in a similar type of interactive activity previously and labeled and flagged the activity genre to be available for future interactive activities. The genre templates may be made available from a master service 188 because the activity has been conducted by a user other than the first user and was supplied for use for other parties. Once the activity has been selected 132, the first entity then establishes 134, or selects, quantum boundaries. Selection 134 of quantum boundaries may happen contemporaneously with establishing 136 an activity total time, e.g. one hour. In the above-mentioned legal example, a user may select quantum boundaries through (i) manually entering the characteristics of the quantum boundaries, (ii) automatically generating quantum boundaries, or (iii) accepting quantum boundaries predefined for the user. Any action by which results in the subdivision of the interactive activity into portions may be considered selecting for purposes of the present invention. The same is true with selecting an activity time, which occur by (i) manually entering the characteristics of the time, (ii) automatically generating a recommended time, or (iii) accepting time predefined for the user. Any action by which results in the application of a total time to an interactive activity may be considered “selecting” for purposes of the present invention.

In an example wherein the total time is one hour and the quantum boundaries number five, the interactive activity be scheduled to include five quantum boundaries each of twelve minutes. Quantum templates 304 may be supplied in a similar fashion as genre templates are provided. Quantum templates 304 may be made available because the first entity 192a has engaged in the exact, similar, or analogous activity. Furthermore, quantum templates may be provided by a master service 188 with access to the activity templates of third parties or because of learning 124 engaged by the system 100 with regard to the tendencies of the first user. The quantum templates 304 may start as predetermined quantum boundaries, which then may be labeled and adjusted 306 in characteristics by the entity. Characteristics of the quantum boundaries may include duration, labels, position, etc. It is meant that any aspect of a subtopic as a transition point, or as the subtopic itself is capable of adjustment to suit the purposes of the first user.

Similarly timer templates 308 may be provided wherein suggested total times are applied to the genre of activity. The timer templates 308 may exist because the first entity previously engaged in an activity identical, similar to, or analogous to the activity in which he intends to engage. The total time may be adjusted 310. The quantification layer 106 is then applied 110 to the interactive activity. By applied it is meant that the system 100 has the ability to either initialize 102 directly software logically related to the activity, i.e. purpose-built software within the system for interacting with third parties; or initialize 102 by acting in concert with software logically related to the activity. An example of software logically related to the provision of legal advice may be GOTOMEETING, JOINME, MEETINGSENSE, and the like. The software makes ready 102 to interact with the companion, or internal, activity software such that the quantum boundaries begin operating with the interactive activity at a meaningful opportunity. A meaningful opportunity is a point at which the use of the system achieves the goals of the system; for the present example of legal advising, the appropriate moment could be (i) a predefined start time (because doing so maximizes the use of time), (ii) the moment at which the companion software begins operation (because triggering the system to operate upon start of the companion software is simplest to achieve), (iii) the moment at which all the participants have populated 140 for the meeting, or (iv) a moment in which the first entity starts the timer. Any of these moments may constitute the initiation 112 of the interactive activity.

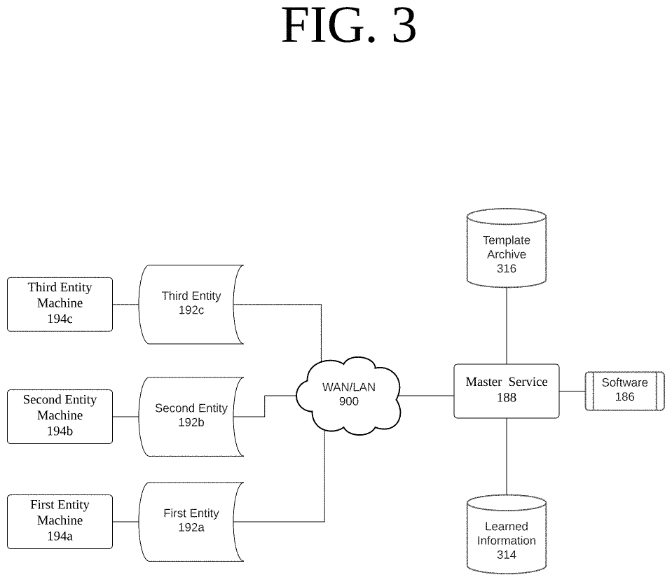

Turning now to FIGS. 1-4, the preferred embodiment of the present invention achieves its goals by the use of substantially silent sensations that are integral within themselves. By sensation it is meant a stimulus that is recognized by a human sense (touch, smell, temperature gradients hot/cold, moisture, or any other stimulus capable of being sensed by mechanoreceptors or proprioception, hearing, visual, etc.). By substantially silent, it is meant that, even if there is an audible component of the sensation, it is both ancillary to and outweighed by the substance of a companion sensation. By way of example, a vibrating device may be used as the sensation instrument 402 to generate the sensation felt by the first user in conducting a meeting. Because many sensations are the result of wasted energy, energy may take one of several forms; for vibrating objects it is often the case that the vibrations are audible as well as capable of being felt. For purposes of the present invention, the vantage point of “substantially silent” is the point at which the second user is participating in the activity. If the second user cannot hear the sensation, then the sensation is substantially silent. This is more of foundational concern when the vantage point considered is the second entity because a “felt” sensation cannot travel distances (generally); therefore, the possibility of being heard by the second entity 192b is considered prior to the relationship between the primary sensation and sound.

It is preferred, however, that the first user is the vantage point, such that the relationship between the primary sensation and sound is considered from its vantage point. Most interactive activities are interrupted by the use of sound. The interruption can be an interruption for either the audience, as passive onlookers distracted from where to focus attention, or the presenter, the active individual who may lose focus as to the issue being discussed at the moment the sound is active. Focus is important, and the present invention offers solutions not found in previous attempts at assisting individuals engaged in interactive activities. To maintain focus, the present invention utilizes an integral sensation. By integral it is meant that the sensation is not bifurcated into two or more information bearing components; a complete set of information is contained within the sensation. This differs from pre-existing timers, for example, that utilize multiple circles to indicate a ratio of time remaining to total time. In such an implement, the user must perform mental calculations based on extended observation of one shape to a second shape. Each shape conveys information; one shape indicated time remaining (and as a numerator of a fraction) and the other shape indicating total time (as a denominator of a fraction). So in total, the brain performs at least five steps: observation of first circle; analysis of first circle; observation of second circle; analysis of second circle; and finally a comparison of the first circle to the second circle. An integral sensation lacks any necessity of comparison a first part to a second part. A preferred sensation includes haptic sensations and light based sensations.

The preferred sensation includes vibrations from a vibrating device. The vibration can be a component of the computer utilized by the first user that is implementing the activity, or by a separate computer receiving instructions merely from the quantification layer 106 as distinct from the activity software, or by a distinct device dedicated purely to receiving instructions from the quantification layer and generating a sensation. The preferred embodiment of the present invention begins the quantification layer simultaneous to the initiation 112 of the interactive activity; each quantum boundary is associated with a sensation of multiple magnitudes. Magnitude for purposes of the present invention includes any alteration of the characteristic of the sensation, including quantity, duration, intensity, frequency; etc. It is preferred to avoid quantity-based sensations because it requires dedicating a portion of the brain to mathematical analysis. It is important to differentiate between quantity and frequency: the sensation may include multiple sensations, but when the primary characteristic is not the total number of sensations, then the sensation magnitude relies on a characteristic other than quantity. A quantity based sensation, for example with the legal scenario discussed above, may include one vibration of one second duration for the first quantum boundary, two vibrations of one second duration for the second quantum boundary, and so on until five vibrations of one second duration are encountered for the fifth quantum boundary.

The use of frequency as a magnitude for haptic sensations is a preferred form of sensation. The use of frequency with haptic sensations means that sensations will likely continue beyond the quantum boundaries and into the quanta themselves. A preferred form of haptic sensation mimics a natural function, such as the human heart; during an early quantum the sensation occurs at a steady, relaxed pace and as quantum boundaries are passed the pace of the vibration increases such that as time is nearing the conclusion of the overall timer, the vibrations occur at a frenzied pace. The frequency of haptic sensations may occur as a rhythm which entails both quantity and frequency, including steady rhythm, increasing rhythm, decreasing rhythm, number of vibrations in the rhythm and the non-linear representation of vibrations (synchopated, etc).

Another preferred embodiment matches the magnitude of the vibration to the boundary quantum; earlier quanta include lighter vibrations, later quanta include heavier vibrations. Another preferred embodiment matches the magnitudes of vibration components to the stage of the quantum boundary. Vibrations prior to a midpoint begin lightly and increase to a heavier intensity; vibrations at the midpoint begin at one intensity and continue at that intensity until the vibration ends; vibrations subsequent to the midpoint begin heavily and degrade in intensity. Depending on the quantum boundary quantity, the difference in intensity can vary with the distance between the quantum boundary and the beginning and end points. Furthermore, different contact types can be utilized to convey information about the quantum boundaries, sharp contacts may convey information about one quantum, while dull contacts may convey information about a different quantum. The vector of the contact may convey information about the quantum boundaries; turning motions may convey information about one quantum boundary, while linear contacts may convey information about another quantum boundary.

The sensations may use light, preferably as a light flash. The flash may have the characteristics of the vibrations discussed above, namely, increase in intensity; varying quantities; variable intensities within a single flash; frequency; etc. Furthermore, because light may be supplied in different colors; one color can convey information about one quantum boundary whereas a different color conveys information about another quantum boundary. Lights may convey information related to frequent uses of light in society: green lights can convey information that the first entity has plenty of time remaining, whereas an orange light can convey information about minimal amounts of time remaining, and a red light means that the time for the activity is drawing to a close. Sensations can be mixed together such that each type of sensation indicates a different type of information, e.g. vibrations for unilateral (e.g., conveying) information and light for bilateral (e.g., question-and-answer periods) communication periods.

Smells are becoming available as sensations reproducible to individuals. Smells may be used as sensations according to the present invention.

A user may select 138 the sensations available to him during the presentation. The sensations may be supplied from sensation templates 312. The sensation templates 312 may be available as predetermined sensations provided pursuant to the system's installation or provided on an ongoing basis through interactions with the master service 188. The sensations 134 available need not be integrated into a template 312; the templates 312 could be supplied according to a general principle, for example increasing in magnitude for a single instance of sensation, and then the sensation can be applied to the template. It is practically immaterial whether the sensation applied to the increasing-magnitude template is light or contact: either could be utilized with such a template. Sensations 134 could be selected as any of the sensations characterized above. The magnitude 312 of the sensation may be adjusted in toto or per quantum boundary.

The first entity 192a, or other entity, initiates 112 the activity and the activity 114 ensues. The interactive activity of the present invention includes any event that includes multiple entities as participants and wherein one entity relies on another entity's interaction for the perceived success of the event.

Use Case No. 1: Professional Task
A team writing a POWERPOINT: 5 people creating 3 pages each racing against each other toward a common goal.

Use Case No. 2: Lawn Care
Lawn mowing: 3 people with equal sized yards of 20,000+ sq ft in the great plains pace each other remotely over a network so that they have more time to play with their children. After a few weeks, they'll know exactly how many sq ft/min they can mow to maximize their day.

Use Case No. 3: Assembly Efficiency
Welding trailer subframes, upholstering medical tables, putting down a subfloor on new construction, managers can get the best out of their production teams in non-variable setting.

Use Case No. 4: Home Improvement
Cleaning out a room: storage unit, garage, basement . . . 4 individuals each take on an infrastructure project for a Saturday. Every 15 min, when the present invention vibrates, they HAVE to take a pic/video in real time and send it to the team to share their progress, both as an inspiration and as an accountability mechanism to ACTUALLY get done what you say you're going to get done. This would possibly include a monetary skin in the game accountability system where, upon [some losing condition], the loser forfeits their money to the company or a good cause or a bad cause (e.g. a Republican's forfeited money being donated to the Democratic National Party, etc) as an aversion stimulus to keep moving, prevent lollygagging, and generate throughput.

As the activity continues, the sensations 118 are applied as instructed in the quantum intervals prior to the initiation of activity. Instructions for quantum intervals need not necessarily be supplied prior to the activity; in some embodiments the quantum intervals may be adjusted or otherwise altered during the activity. When an adjustment is made (by a user authorized to make adjustments) that adjustment is synchronized across the network to all other participants for that and future quanta.

Use Case No. 5: Pitches
A VC company gives an inventor three minutes to pitch his idea over the phone. Two minutes into the pitch, the VC company decides they are almost really interested but need more details to decide. The senior partner adds four minutes to the time and at the moment he does, all three partners' timers increase to seven min and the inventor's timer increases to seven min substantially simultaneously (barring typical network traffic delays).

The first entity 192a as described herein is meant to be the protagonist in the invention description: the use of “first” is not to have significance other than the fact that there need be at least one actor to consummate the present invention. The first actor has access to a machine, which may include a computer, which may include storage 206 and an ALU 204. Because the activity of the present invention includes interactivity, there is at least a second entity 192b. In other versions of the present invention may utilize solo activity. The second entity 192b may have access to a machine, which may include a computer, which may include storage 206 and an ALU 204. A third entity 192c with a third entity machine 194c may be included in the present invention. There is not a practical limit on the number of participants that can be included in the present invention. The participants, including the second entity 192b and the third entity 192c, may join the activity via a LAN or WAN or other network 900. The entities are populated 140 in the activity and the interaction begins.

As the activity commences, not only are the sensations 118 applied pursuant to the quantum schedule, but additionally information is captured 116 during the course of the activity. Captured information 314 may include any information helpful to the future implementation of the present invention, including such information as a success rate of achieving quanta conclusion during the quanta boundaries, the longevity of particular topics, the success ratio of meetings as related to time or date of meeting, the longevity of quanta as labeled, the number of times quanta boundaries are adjusted on the fly, by how many minutes on average, what percentage of the time, the success ratio of particular presenters, etc. Much of the learning 124 involved in the present invention revolves around capturing 116 during the course of the activity information related to the activity. Preferred information captured 116 involves basic information, primarily the success of the first entity in concluding the topic of the quanta prior to encountering a quantum boundary. In the same way that a long distance runner attempts to pace himself during the pendency of a race, so does an able public speaker attempt to reach milestones at an appropriate rate. The existence of the quantum boundaries provides information to the first entity to modulate the rate of the activity as necessary.

Information may be captured 116 automatically; semi-automatically, or manually. A preferred means of semi-automatically capturing information includes the use of triggered prompts from the computer, preferably hands-free (wired or wireless headset) (headset meaning device like current headphones with or without microphone able to receive and transmit audible signals), consisting of a question from the computer: “Please enter comments on the last fifteen minutes?” and an answer from the user such as “not now Siri” or two taps onto a tap-receiving sensor (on the phone, watch, etc) if busy or, if not busy, an answer like “layed down five pieces of subfloor material, glued all of them and finished nailing four”, a voice to text (VTT) transcription as well as an audio recording of the response into a database-like repository, followed by a prompt to the computer from the user, like “repeat”, and a text to voice (TTV) reply by the computer to the user of what the computer “thinks it heard” and stored. If mistranscribed, the user can ask to “play audio” whereby the computer will play the recording to make sure it's clear and not incomprehensible due to background noise. If the recording is viable, the user can end the interaction by saying “edit later” at which point a “to be edited” flag will appear on the record of that interaction quanta. If the recording is not viable, the user can say , “Siri please re-record”. In this manner, details about the accomplishments within a quanta can be sufficiently captured and stored for later analysis and cleanup without the user touching his computer every x minutes as his hands may be full or otherwise immersed in the project.

A preferred means of manually capturing information includes the use of triggered feedback from either the first entity 192a or another entity 192b, 192c to learn 124 via mapping the position of the activity and relating the position to the quantum boundary applicable thereto. For example, quantum boundary scores may include a correlation of time differentials, such as q₁: +5 s; q₂: +2 s; q₃: +1 s; q₄: 0 s; q₅: −10 s. Each differential relates to the time gap between the start of the quantum and the location (in time) of the applicable quantum boundary or the approaching end of the quantum and a differential related to that end (one minute left would imply End of Quanta or Boundary 2 minus 1 minute without regard to start boundary or duration of quanta (q_{End}: −60 s). The first user may examine his score chart to learn from his history to achieve greater success or speed/quality couple in future activities. Success as a “speed/quality couple” could be measured in “widgets built correctly with no defects” and compared with “number of widgets within that quantum interval”. Depending on the activity . . . one, the other, or a cooperative system of both speed and quality might be appropriate. Alternatively, the first user, or the system, may learn that the appropriate remedy is not an adjustment of the activity, but rather a re-evaluation and adjustment 126 of the appropriateness of quantum templates based on past performance. As with any learning 124 associated with the present invention, the learning may be based on the first user to apply to the first user, or the first user to apply to other users, or other users to apply to the first user. The system 100 may recommend, or perform with prior approval of the first user, an adjustment 126 of the quantification templates or quantification layers.

Automatic capture 116 of information is more complicated. Automatic capture includes any means of acquiring position information other than the manual input of a position indication from a user. Examples of automatic capture include correlating position information with key words, key sounds, key documents (e.g., the presentation of a particular chart equates to reaching the third quantum boundary, or particular slides on a slideshow slide represent quantum boundaries), hand gestures, hidden symbols, or word recognition on the part of the system. Any of the aspects learned 124 by the system 100 may be saved 314 and applied to future uses of the process 100. To the extent that any genres, quanta, timing aspects, sensations, or the like may be advantageous, they may be stored 202 in a master template archive available to the master service 188. The templates and recommendations may be published 128 directly to the first user or, as the case may be, to third parties.

It is another aspect of the present invention to provide incentives to achieve timed goals in interactive activities. The most notable time goal includes termination of an activity at the conclusion time thereof. Entities may drop off 142, and the process 100 can ensure finality by involuntarily concluding 144 the activity with a hard cut-off at the end, or to the extent that the first user is lagging behind at the quantum boundaries, then the process 100 may conclude the activity prematurely at a quantum boundary or other premature point in time. Entities may otherwise drop off voluntarily 146 at the conclusion of the meeting or other point in time.

The present invention may feature a host of post-activity events 190. A preferred version of post-activity events includes publishing 122 a score for the activity related to benchmarks known to the process 100 in its learned information 314 database. Scores may be based on the reaching the quantum boundaries pursuant to the time allotment of the quantum template applied to the activity.

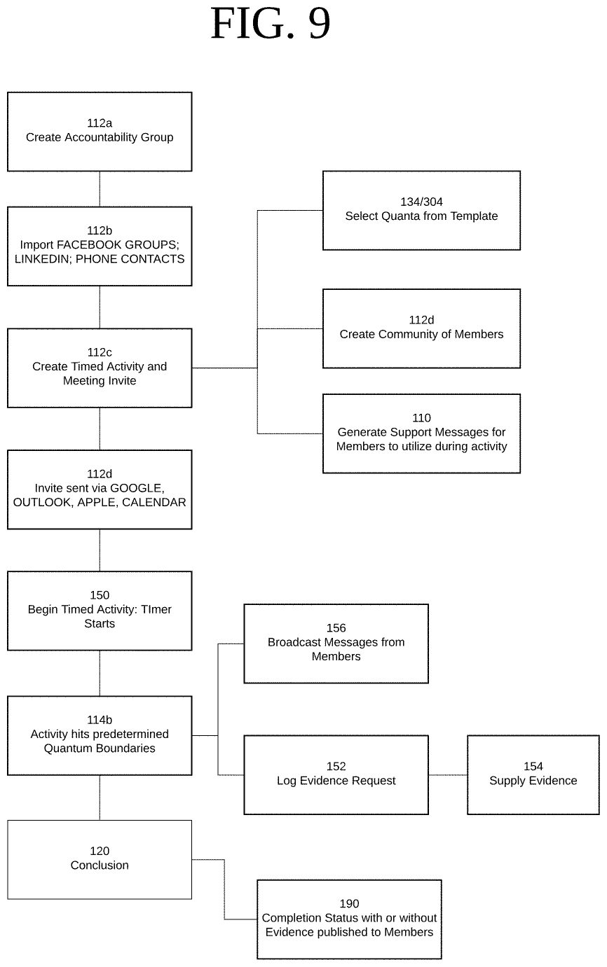

Turning now to FIG. 9, it has been a well-documented fact that when an individual is held accountable to at least another individual and preferably a peer group, the probability of completion and often timely completion of an activity greatly increases. This observation stems from humanity's relationship to avoidance of shame, social recognition, a desire to look good, responsible, and competent. The higher the perceived social rank of an individual to whom you become accountable, the greater the effort expended for timeliness and accuracy, but any accountability to another human by far exceeds our accountability to ourselves in general. E.g. a presentation to the CEO due on Friday usually gets done by Friday, and your portion of the code for a computer program due on Thursday and is required by the rest of your equal ranking peers to proceed to the next phase of the project usually gets done by Thursday. However, the basement you want to clean out next weekend may get done by next weekend, next month, next year, or never . . . I mean, who else would know of your commitment or care? The present invention seeks to leverage these facets of humanity to affect a greater completion ratio for the undertakings you want to have done (usually personal in nature) as well as the projects you need to have done (usually work related).

To create the requisite accountability for a desired or necessary project 150, the user could create an accountability group 112a of at least one other person to whom the computer will send notifications 152/154 of incremental progress along the project path in real time or to whom the computer will notify 150/190 the beginning and end of a project. E.g. “Frank has begun a project called Cleaning Out Basement today at 10:04 am. He estimates he will be done by 9 pm. Would you like to cheer 156 him on [hourly], [at the halfway point], [at the end of his project]?” Messages of support or criticism can be created 110, as part of the activity initiation, by members on-the-fly or selected from a pre-generated list of related messages, which may or may not be templated to relate to a templated activity. Furthermore, a member may select to send messages at subsequent times as selected from a prior time.

In one embodiment of the present invention, two entities communicating over a network are geographically disparately located one from the other. In other words, the participants cannot perceive the other through their normal human senses, i.e. hearing, sight, smell, etc., and rely on the present invention as the sole basis of interaction. The present invention can apply to individuals in different levels of a house, different rooms of a structure, different states, different countries, and the like. A significant objective of the present invention is that it may replace the verification that normally takes place with human senses directly.

At every quantum boundary, or end of the interaction, there could be a request 152 to send a real-time picture or video of progress or activity completed. This would require use of the device's camera in real time, or pictures taken 154 from the app with the camera (with proprietary encoding of a timestamp for say, an overnight project), but will not allow access to images/videos already stored on the device as these pictures are unencoded and can be edited with software external to the app. This architecture would prevent a use case such as doing double work on Saturday and then sending Saturday's pictures on Sunday as a false representation of “progress on Sunday”. However, a picture every fifteen minutes of an overnight project captured by the app and timestamped, can be sent as a package of pictures the next morning to your boss as proof of not sleeping on the job, without waking her up every fifteen min with a notification.

Automated notifications: computer initiated or server initiated. Humans will go to almost any length to avoid shame an accountability when the successful/timely completion of a project looks bleak. In the above example, if at 8pm on Saturday, Frank is not even close to cleaning out his basement, he could turn his phone off so that it doesn't send the message of Task Completed Reminder to his accountability group, he could then later claim a dead battery, inoperable phone, etc. In a ‘Burn the Boats’ mode, his project notifications can be managed by a server external to his phone, such that, when his scheduled completion time is done, the server will notify his peer group and prompt them to check in on progress, request task completion pictures, etc. Over time, people's estimation of project lengths will become much more accurate and their ratio of execution of desired projects should significantly increase, when compared with their non-accountable ratio.

When multiple people are not in the same room and they are bounded by same time to get something done, where they are rushing against the clock like a gun to the head effect, there is heighten level of emotions occurring where they feel responsible and accountable to get said activity completed on time. The effect of accountability and feeling the pressure to complete somethings is magically occurring when people are sharing the countdown timer.

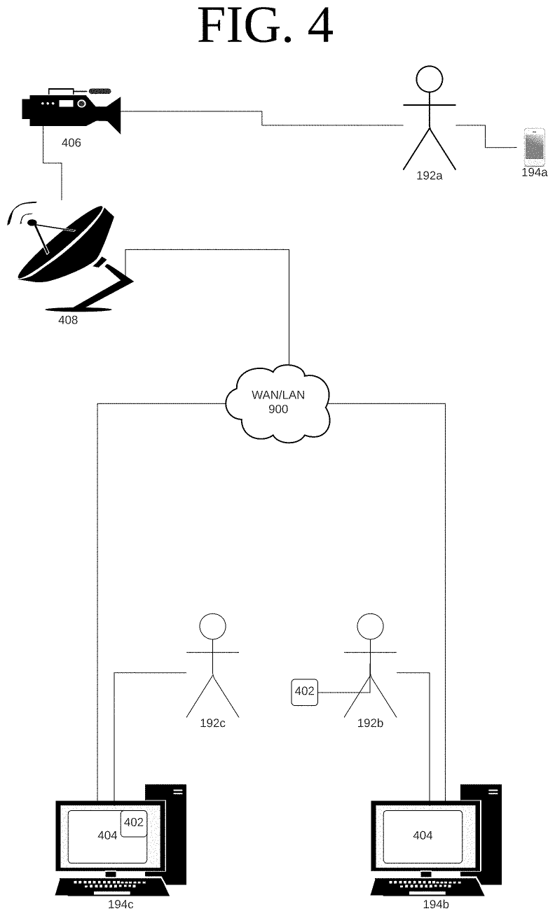

With particular emphasis on FIG. 4, the present invention need not feature the process 100 aggregated upon a single implement for the first entity 192a. The first entity 194a may, for example, be a public speaker that relies on a smartphone 194a as the computer that holds the sensation application device. Audiovisual recorders 406 may capture data related to the activity which is then broadcast 408 across a network 900. The software 186 may reside on a separate device, e.g., the master server 188, and may send instructions over the Internet to the device 194a possessed by the first entity 192a for application of sensations. The sensation application device can be singular or a plurality. The device(s) can be integrated into the smartphone or separate (watch, vest, belly belt, pants with multiple sensation-generating pockets, etc.). The sensations may be adjusted by entities other than the first user, e.g. a producer, or other entity 192b, 192c. It is a feature of the present invention that the initialization 102 of the present invention may permit the inclusion of user entities as the experiencer of the sensation for whatever part they may choose to play in the activity. As an example, during a presentation by the first user 192a, the first user may receive a sensation indicating that he has reached a quantum boundary appropriate to transition the presentation to the third entity 192c. The third entity 192c from his machine 194c may begin the active role in the presentation utilizing his machine as both the conduit of the software, but also as holding the sensation device 402. Here, the sensation device 402 for a tower-type computer preferably includes a screen portion reserved for the transmission of light sensations. Furthermore, an attachment bearing a dedicated sensation device 402, for example, a vibrating device (similar to those widely used by restaurants for waiting lists) in signaled communication with the computer via BLUETOOTH signal, WIFI signal, corded connection, or other. The second entity 192b may then accept the active role from the third entity 192c, and with a disparate computer system operate the communication software from his machine 194b while utilizing a dedicated sensation device 402 portably attached to his person.

Geographically disparate is where the timer is not only located in one room and not within sound wave/audible ear shot. If a group of people are located across multiple rooms, floors, buildings, zip codes, or different countries, they can be synced by the same timer activity and hear, see the same countdown timer to complete work-related activities or personal activities/tasks. Geographically disparate timer countdown can be on a distributed network notification—any location/loci, that is not on the same field or on the same room or can be heard through audio speaker communications—speakers can travel only so far. A communication network can be a wide area network, WiFi, CDMA, GSM, or other cellular network vs self-contained in one room.

In another preferred embodiment of the present invention 100, and as depicted in FIGS. 1-4 and 8-9, an autonomous activity 114 bot initiates the activity process 100 rather than relying on express initiation from an entity 192. Instead an entity 192 selects 106 quantification for a future activity, which may be singly occurring or recurring. Entities use all types of existing conference call technologies for simple one to one calls with very little outcome or change in their conversation and results. Its cumbersome and antiquated; this area is prime for a shake up. Calls that use conference bridges do not have inherent attributes that serve to increase the quality of the call or the result of the phone conversation—so phone calls are ripe for disruption. Is it possible to having shorter result oriented calls that end on time and to easily schedule future calls where a service calls all parties automatically at the designated time?

Entities scramble to find the dial-in number and codes; at times entities are in the car and try to find a safe way to dial the number and enter the access code. Entities have calls scheduled on A calendar and steps to schedule the call requires cut/paste of conference bridge information into an outlook calendar invite and hitting send; then entities have to remember to call—so entities have done multiple steps so far and then entities have to try to hang up on time because it will have a ripple effect on a day and entities have just repeated several points over again and the call is lacking energy and urgency to make something happen imminently.
Entities need to remember to dial in on time, and many entities are late and calls are not taken seriously—it becomes a call about a call. What if calls included accountability in a soft way? The present invention forces a non-awkward forcing function to have a conversation in a limited time, say ten minutes, so that an entity can schedule an increase quantity of meetings and have a much more efficient week and permit an entity to have, say sixty telephone calls a week, (personally or professionally) in the same timespan that might normally occupy five telephone calls

The present invention may a schedule a future call between two entities (one to one calls are approximately 70-80% of a professional communication process during a work week; but most rely on emails to communicate on action items and next steps; or calling a parent repeatedly Mon/Wed/Fri for five minutes. The present invention can be setup to call all parties on time, ie. at time of scheduled call. WebEx and GoTo Meeting and other conferencing services, of which the present invention can be integrated as a subroutine, can call one or more entities via VOIP once an entity enters a meeting, and can assume the presently absent function of taking the lead in calling all entity participants on time without the need to log into something or enter a access code. As entity could have a telephone with it and automatically get a call by the present invention.

Presently phone calls between people are dependent on someone initiating a call and running through the steps of finding a telephone number or dialing it, and waiting for that person to pick up and then leaving a VM, which presents a ripe scenario for a future game of “phone tag.” One to One calls account for a majority of calls people need to make as compared with traditional conference calls; but a reduction in one to one professional and personal calls is happening due to an increase in the quantity of SMS, emails, social media as compared with the old fashion way of connecting with another human through voice—if a face-toface meeting is impractical. Human being can be considered analog because humans tend to operate in an analog fashion, but humans nonetheless use digital mechanisms to communicate in an effort to accomplish tasks, and move the ball forward on activities and tasks to only find out that digital means, designed to aid us, actually interfere with getting the right response in a timely fashion. It could take several email exchanges before an activity is resolved or completed.

In a professional environment phone calls happen by sending a calendar invite with a time and day. The specified increment of a meeting is thirty minutes normally or longer. One can specify fifteen minutes, but meetings can rarely be constrained to this artificially limited timespan. The present invention results in meetings having a suitable degree of accomplishment over timpespans of two, five or ten minutes.

An entity can schedule an activity (call, meeting, individual tasks but under the same duration/start/end time, group task, . . . ) in the future via a smartphone application, software application, a device, message SMA, email, calendar invite, or a web service. The initiation mechanism process (which may occur via phone app, software application, a device, message sms, email, calendar invite, or a web service) is send to a server framework/service engine (E.g., Prompter, Call Boss, . . . ) in the internet/cloud based solution. An example of the setup that appears to be invisible to the end user and not impacting typical professional behavior (the present invention does not need to inject new behavior patterns in order to appear invisible to the user-entity) is that the initiator of the event or call between two people, could simply use its normal everyday calendar system to make meeting invites and add as a third invite (including as merely one step without a user-visible mobile app or web application needed) the present invention. So, an entity may add the present invent invention as a third (in meetings involving two entities) invitee or as the ultimate invitee in larger meetings. The present invention may retain the contact information, particularly telephone numbers, for the telephone meeting activity in its database—or the present invention may acquire contact information through other automatic or manual means, including recognition through the meeting invitation. The present invention will know how to pull info out of the meeting invite or the person setting up the meeting has an account related to the present invention and all telephone numbers stored in a person communication device can be stored in their user profile or add the person's number to subscriber's account.

One way to initiate the system and set a future automated event is a third invite could look like: Email: John@fakeurl.com. A present invention invite appears as such: “create a calendar event from any calendar system, include you, the guest, and Prompter in the invite, click send and Prompter/system comes back with a response (complete or missing info)—if it doesn't have phone numbers in the system or sees phone numbers in the notes—if it has phone numbers—Prompter will call both people. So just CC PROMPTER in the calendar invite.” Once the meeting has been arranged, all party-entities will instantly receive an email or SMS with details to the names of people in the meeting, the duration, and when it will occur. For people that do not have the mobile app, there will be a link to download it but having the app is not required. If the mobile app is used to initiate a future event, several participant fields exist and all you have to do is select from “contacts” the people included in the meeting. If the person does not appear in your contact list, one can manually add their international number very easily into a field. On a mobile app, you select the time of the call and the date and if its 2, 5, or 10 mins long. Then another option for a mobile application version of the present invention is this a re-occurring call, select the days for when. When you click on “GO”, everyone receives a SMS on the details with an optional calendar attachment that everyone can click on to add it to their particular calendar or they can simply add the info themselves. A populator 140 will call 114c all parties at the designated time specified in the meeting invite, so the populator will know how to read the time/date of the invitation and the telephone call will end 144 at the specified time, i.e. on time every time. There are three preferred option selections 136 for duration of the call or activity: two minutes, ten minutess, and ten minutes; and in more preferred embodiments, this is a closed set of potential teim spans. Present meeting calendar systems do not allow for a two minutes call/meeting and some calendar systems do not allow five minute meetings. One of the benefits of the present invention is that it is not constrained by the timespans of mainstream calendaring software applications.

The present invention will inject 118 tonal cues, preferably audible, to create awareness to all parties to alert where they are in time so the activity completes on time with several warnings and alerts that can be configurable 136. No more awkward excuses to get off the phone: the present invention becomes the “bad guy” and urges entities to get their thoughts out and have action-oriented calls/meetings. For personal use, the present invention can be used to stay connected with friends and family by setting up future consistent check in calls for five minutes or ten minutes on specific days and times. The server framework/service engine will do all the work, to call all parties on time and start a timer countdown for all sides to hear so everyone knows how to pace themselves appropriately and get what needs to be said out. The system ends 142 the event for everyone exactly at the designated 136 times. At the end of the activity or call, the system collects 190 data on if the event was productive or energizing.

In terms of a sales call initiated by a sales person to a new prospect, the Productivity Rating of sales people/Productivity Meter that can be applied to historical meetings 190 can be valuable in learning if the salesman will waste time or not. Customers will be more inclined to accept an invite from a sales person if they knew they had a high productive rating. The rating may affect sales people, judging whether they are highly efficient, effective, do not waste time.

The present invention knows how to interpret information within a meeting invite, makes the calls, waits for everyone to answer, when everyone accepts the call, the server timer synchronization starts for everyone, the server injects tonal cues into everyone's receiver/handset so everyone hears the same cues at the same time, it will start the call at the same time, end on time, and hangs up. Once the meeting invite has been accepted by all participants, the service will send instructions to have additional agenda notes and create desired outcome notes up front where people can view before and during the call to help keep things on track and make people think about them before the call happens to further insure desired outcomes end on time.

During the activity 114, the quantification layer is applied 110 which serves to keep the activity proceeding on an acceptable pace. Upon the activity, being accepted by all participants, a timer countdown synchronization will start for everyone, a voice automated system or a celebrity voice of end user's choosing will announce “this is a 10 min activity and will end on time, everyone will hear at the same time, cues at the 5 mins marker, 1 min marker, 30 sec marker, and the last 10 seconds with beeps”. For experienced users, this automated announcement in the beginning of the call can be turned off. Its important to note, that the activity begins when both parties accept the call if it's a phone call type activity. If only one person answers, then a voicemail is left for both parties and a reschedule SMS is sent to everyone or the option to delay the call by mins or hours into the future for that day. The framework enables an infinitely customizable timer both in timer intervals and the frequency and type of notices within the interval. For example, an entity can create a timer that goes off over the course of an hour long meeting where the first interval is twelfth minutes, the second interval is seven minutes repeated twice, the fourth interval is five minutes repeated three times, the 8th interval is 2 minutes and then back to a five minute interval followed by a 4 minute wrap up and 8 Minute question and answer. Add up all those numbers and you get 60. Depending on the overall length of task, you can add any number of intervals by adding the plus sign and delete intervals as needed by hitting the minus sign. Additionally, intervals can be based on prior or later intervals.

Within each of variable intervals, you can choose to keep the default settings which are the notifications as they presently may exist (e.g., a one minute warning thirty second warning and ten second countdown. A user may add any number of customized tones. To add a cue simply hit the plus sign on the cue and customize it or if you want it identical to the cue you just customized, hit copy. You can delete cues by hitting the minus sign. With this one or two line framework, you can add as many intervals as desired, a variable number of queues were interval, and the mix and match total cues with vibrational cues or whatever. Three functionalities may be added from the design [save as, share, and import]. Design the format of this metadata and save it as a .CUQ (Customized User Cue). Side note: after interval length, add in the ability to name the interval. For instance, for a meeting, the person who will be talking about that agenda topic, or the name of the agenda topic, or, in the case of habits of the successful, the name of the activity. Side note, if a topic (interval) gets completed early, the user should be able to interact with the timer such as tap the phone twice or shake the phone twice to get it to go to the next interval. That'll give time back into your day or time back into the meeting,

The communications can be dropped 142 automatically 144 or voluntarily 146. There is power and respect when activities conclude on time and most people dread the meetings about meetings or calls “about calls.” There has to be new paradigm that forces people to have the intention and focus to get things done and get things done within a specified time allotment. The communication is dropped at the end of the timer countdown but not with several cues notifying the participants that the end is near so as to give people the highest assurance they can get done what they set out to do. Also for a phone call scenario, people have to come up with awkward ways to end a call that goes on longer than needed or people take too much time to express their points and ends up repeating themselves and also people don't like to use the phone much in a professional or personal use case because they are always afraid of how long they will be on the phone for. So now that all comes to end by forcing the activity to end at 0 seconds with no option to extend. If people need to speak more or continue they can setup another 5 or 10 min call to do so but the solution helps trains people to learn a new relationship to time while using the solution, it helps us to build muscles, metaphorically speaking, around time we don't have today. Ending on time is an art and a muscle that needs to be developed.

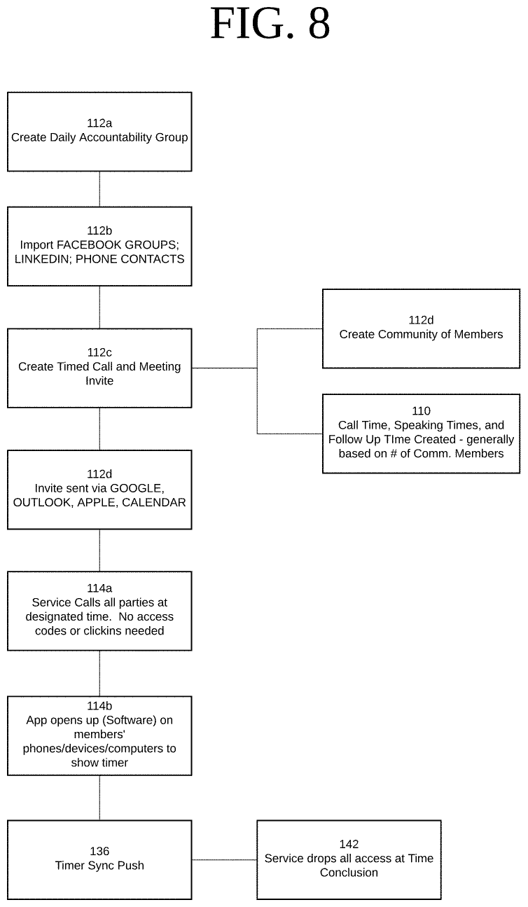

Turning now to FIGS. 8-12, messages and other responses from members of the activity can be applied 156 to the activity. Follow-Up email after call within 5 mins—participants will receive an email with action items captured during the last 30 seconds or when certain trigger words are used like “Action Items are” or “John you owe me” or “In summary.” Using 124 the imbedded listener and AI, the system will transcribe words into action items and send both parties an email that holds everyone accountable and keep things action oriented after the call. AI within call conversation can be utilized 124 to be able to show emotions and tonal energy in real time so people can modulate their tone and increase how they make a person feel right before they hang up. People do not remember what you do or how you do things but will always remember how you make them feel. Energetic Phone Calls can increase through using this AI awareness of a person's energy level and emotional state during a call. The service engine can plug into third party vocal emotional AI engines such as the existing tool “BeyondVerbal” in order to determine each participant's emotion on the call. In real time the subscriber of the service can see the emotional level of the receiver of the call and then work to improve and raise the level of emotions to happy, excited, or energized so right before everyone hangs up, the call can be remembered as positive and productive. The present invention in addition to uniting entities in meetings will also have its own capability to recognize key words towards the last min of the call such key words could be “Action Items are” or “John you owe me” or “In summary”, when these key words are heard, the system will transcribe everything after that and turn it into meeting mins or action items owed by both parties to help keep each other accountable and convert it into tasks with dates.

When a person invites another or when more than one person accepts to start an activity at the same time, they can select a “Burn The Boats” mode. By “Burn the Boats” it is meant a reference to Cortez-style attitudes that eliminate the possibility of retreat and as such there is no going back, and one becomes fully committed with accountability, with people observing a timer countdown. Alternatively, users can simply use the present invention to start a timer countdown for everyone that has opted to get something done at the same time/date and under the same timer duration—everyone will race against the timer to get their collaborative activity complete or independent activity completed. When people race against the clock TOGETHER, at the very end there is a unique feeling and ripple effect that impacts people around time, there is a human energy exchange through the release of endorphins and “feeling the rush,” moving faster with urgency and with intention.

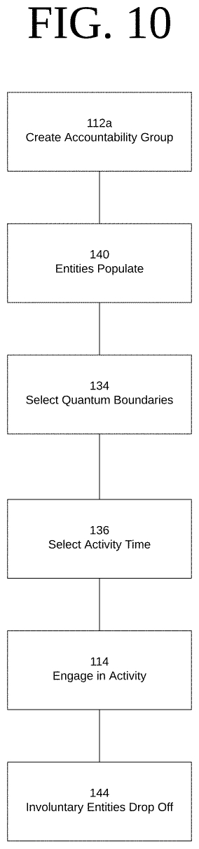

Such an approach is directly shown in FIG. 10 whereby the present invention includes a process that populates 140 a list of contact information and identities. The identities can be prepopulated or an AI can supply them from a larger culled list, or any other means for creating an accountability group 112a. The process contacts all identities with an indication 136 of an allotted time for an activity. The time can be pre-selected or chosen by an AI based on a benchmark for the activity. The activity is dissected into quanta 140 and the activity is engaged 114 based on the activity as subdivided into the applicable or modified quanta. Once the time has exhausted the entities are automatically dropped 144 from the activity.

When we work by ourselves to get something done and use an egg timer or pomordoro timer, it does not have the same level of intensity and quality end result as if we raced against each other to get something done at the same time. The present invention further uses an Activity Timer, which is a platform/system subprocess of the present invention that acts as an assist for the brain. The present invention will have an ecosystem of platform, back-end services and applications to help track people's time, calendar and activities with the potential of artificial intelligence to evaluate and look for efficiencies. The present invention helps people understand what makes them most effective and efficient and use AI to help people offload tedious/mundane tasks and focus on what matters and where their brain power could be of better value. Furthermore, the present invention serves as the foundation for any activity that contains more than one person to move forward on anything with others involved. The present invention creates a sense of time awareness that is often the primary difference between the successful entrepreneur and the dithering amateur.

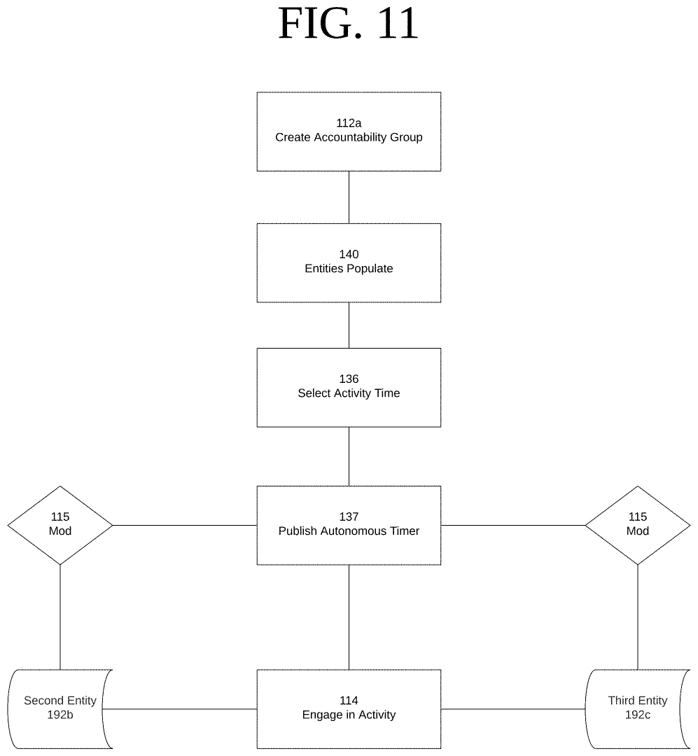

Turning now to FIG. 11, the process of the present invention can further include the publication 137 of an autonomous timer. An autonomous timer is a time reflection device or program component that relies on a timer exterior to the device upon which the process may be running. For example, the process of the present invention ideally runs on a mobile telephone or mobile computer; however, an autonomous timer does not look solely to that device's internal clock for either the start of a timer or the diminishment of allotted time. This can be particularly beneficial for entities working in different time zones that lack an agreed-upon standardized time. In such versions of the process, it is preferred that the entities 192a, 192b, 192c be capable of modifying 115 the time remaining by contacting a physical or virtual button. The button may include a form-filled increase in time, or a standardize increase in time such as +5:00 or +10:00 or +00:30. The activity can be engaged 144 until time has reached a zero-moment.

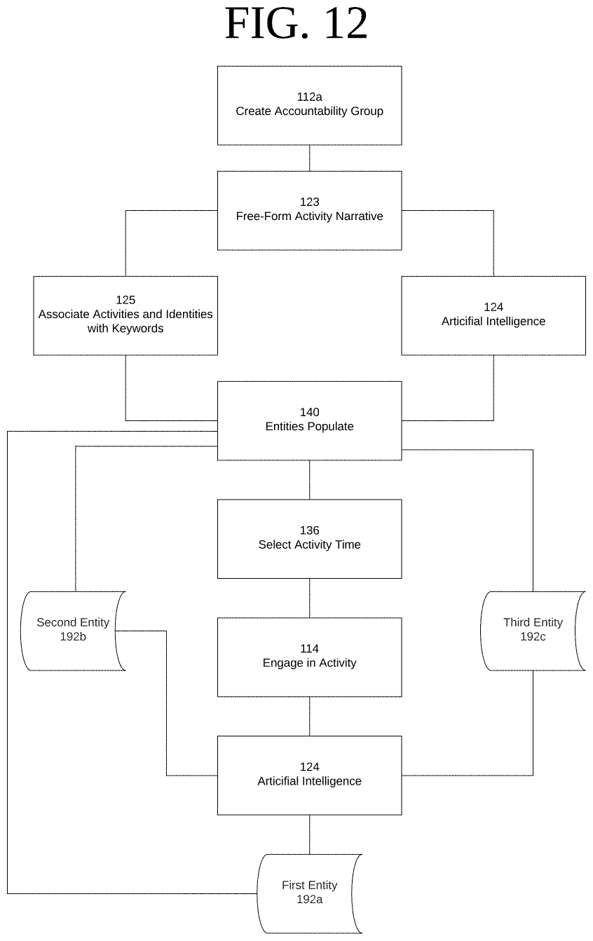

Turning now to FIG. 12, the present invention includes a program having a list of entity 192a, 192b, 192c identities. The preferred means for the process to access the identities can be two-fold. In a first version of the present invention, the activity is provided 123 and analyzed by the artificial intelligence 112 of the present invention and selects entities from a secondary program, e.g. LinkedlN or contacts related to the activity. In another version of the present invention, identities can be associated with particular activities such that when an activity 123 is named, the identities can automatically be notified, invited, or simply suggested as participants in the activity. The first entity may accept the identity list, or otherwise auto-send invitations (or automatic enrollment) to other participant entities. Also, the present invention may include a list of identities and a visual representation of the activity (e.g., a box). The first entity may drag-and-drop identity entities into the box for invitations to the activity. Also, the present invention may includes a list of pre-set keywords, or entered keywords, that the present invention can associate 125 with particular identities. For example, the identity “Mike” can be associated with “household chores” and “business decisions” and “branding.” When the first entity creates a “branding” meeting, by either manual textual entry or a narrative that includes the keyword branding (as discerned by the AI), Mike can receive an automated invitation to the activity.

An acceptance, or refusal to decline as the case may be, spawns a timer for the group of real time or remaining time as the entities populate 140. The time runs until a zero-time or pre-identified time is reached for the activity. For the instance many of the telephone calls or narrative meetings, the present invention can include AI 114 that scans for keywords related to follow up tasks related to the meeting, particularly for follow-up action items. As part of the quantum boundaries selected, one quantum, ideally the final quantum can be predesignated as a moment to narrate action items for the AI. Doing so drastically streamlines the processor load borne by the AI so that if the final quantum is selected for AI scan, and the quantum is, say, forty-five seconds, the AI can wait until the final quantum to activate. During this forty-five second quantum, the entities can announce action items such as “Mike, should provide potential branding names by October 5 at close-of-business” to which the AI can parse and create a follow-up calendar entry—or perhaps a follow up meeting with benchmarked quanta.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. An activity synchronization process comprising:
connecting a first computer operated by a first entity to a second computer operated by a second entity, geographically disparate from said first entity, over a communication network supporting an audiovisual communication protocol for an interaction activity, said first computer having an audiovisual recorder;
applying a quantification layer to said interaction activity dividing said activity into multiple discrete quanta with at least two quantum boundaries;
alerting said first entity during said interaction activity to said quantum boundary with a sensation from said first computer;
forcing an audiovisual capture from said audiovisual recorder commensurate with at least one quantum boundary; and
indicating a status of said audiovisual capture to said second entity.

2. The process of claim 1 wherein said alerting step includes alerting said first entity with a sensation at a first quantum boundary having a first magnitude and with said sensation at a second quantum boundary having a second magnitude unequal to said first magnitude.

3. The process of claim 1 wherein said alerting step includes alerting said first entity during said interaction activity to said quantum with said sensation having a magnitude logically correlated to a relationship between said quantum relative to said interaction activity.

4. The process of claim 1 further comprising the step of mapping said interactive activity in relation to said quantum boundaries.

5. The process of claim 4 further comprising the step of scoring said interactive activity in relation to said quantum boundaries to generate a quantum score.

6. The process of claim 5 further wherein said applying step includes applying a recommended quantification layer having attributes affected by said quantum score.

7. The process of claim 1 wherein said applying step further includes applying a quantification layer from template quantification layers based on an activity genre.

8. The process of claim 1 further comprising the step of broadcasting predefined interaction messages to said second entity over said second computer, the selection of which permits the transmission of at least one interaction message to said first user over said first computer.

9. An activity synchronization process comprising:
connecting a first computer operated by a first entity to a second computer operated by a second entity, geographically disparate from said first user, over a communication network supporting an audiovisual communication protocol for an interaction activity having a pre-determined completion time;
applying a quantification layer to said interaction activity dividing said activity into multiple discrete quanta with at least two quantum boundaries;
indicating on both said first computer and said second computer a synchronized timer adapted to countdown said pre-determined completion time during said interaction activity and alerting at least one of said first user and said second user of at least one of said quantum boundaries; and
auto-releasing from said connection over said communication network said first computer from said second computer commensurate with a conclusion of said interaction activity.

10. The process of claim 9 further comprising the step of publishing a success status for at least one quantum related to the timely completion of a quantum activity within said quantum boundary.

11. The process of claim 10 further comprising commencing a commercial transaction based on said success status.

12. The process of claim 9 further comprising the step of broadcasting predefined interaction messages to said second entity over said second computer, the selection of which permits the transmission of at least one interaction message to said first user over said first computer.

13. The process of claim 12 wherein said broadcasting step includes storing at least one interaction message for subsequent transmission related to a quantum boundary.

14. The process of claim 9 further comprising the step modifying at least one quantum with a quantum modification protocol adapted to alter time associated with said at least one quantum.

15. The process of claim 14 further comprising the step comprising modifying at least one quantum with a quantum modification protocol, accessible to said second user and isolated from said first user, adapted to alter time associated with said at least one quantum.

16. The process of claim 9 further comprising the step of logging an audiovisual capture from said audiovisual recorder commensurate with at least one quantum boundary.

17. The process of claim 9 wherein said indicating step includes alerting said first entity with an integral sensation at a first quantum boundary having a first magnitude and with said integral sensation at a second quantum boundary having a second magnitude unequal to said first magnitude.

18. An activity synchronization process comprising:
connecting a first computer operated by a first entity to a second computer operated by a second entity, geographically disparate from said first entity, over a communication network supporting an audiovisual communication protocol for an interaction activity, said first computer having a status indication recorder;
applying a quantification layer to said interaction activity dividing said activity into multiple discrete quanta with at least two quantum boundaries;
alerting said first entity during said interaction activity to said quantum boundary with a sensation from said first computer;
forcing a status indication capture from said audiovisual recorder commensurate with at least one quantum boundary; and
indicating a status of said status indication capture to said second entity.

19. The process of claim 18 wherein said alerting step includes alerting said first entity with a sensation at a first quantum boundary having a first magnitude and with said sensation at a second quantum boundary having a second magnitude unequal to said first magnitude.

20. The process of claim 18 wherein said alerting step includes alerting said first entity during said interaction activity to said quantum with said sensation having a magnitude logically correlated to a relationship between said quantum relative to said interaction activity.

21. The process of claim 18 further comprising the step of mapping said interactive activity in relation to said quantum boundaries.
